(19) United States
(12) Patent Application Publication
(10) Pub. No.: US 2025/0336574 A1
(43) Pub. Date: Oct. 30, 2025

(54) METHOD FOR PROCESSING COAXIAL CABLE

(71) Applicant: SHIMADZU CORPORATION, Kyoto-shi (JP)

(72) Inventors: Takuro KISHIDA, Kyoto-shi (JP); Hiroki OTSUKA, Kyoto-shi (JP); Yukimichi UNO, Kyoto-shi (JP); Haruki OSA, Kyoto-shi (JP); Naoto UENISHI, Kyoto-shi (JP); Tomoyuki OSHIRO, Kyoto-shi (JP); Yuta MIYAZAKI, Kyoto-shi (JP)

(21) Appl. No.: 18/835,064

(22) PCT Filed: May 12, 2022
(86) PCT No.: PCT/JP2022/020059

§ 371 Date: May 12, 2025

(51) Int. Cl. H01B 19/00; H01B 11/18; H01J 49/40

(52) U.S. Cl. CPC H01B 19/00; H01B 11/18; H01J 49/40

(57) ABSTRACT

A method for processing a coaxial cable (60) for applying a voltage to a time-of-flight mass spectrometer (10) includes a folding processing step S2 and a burying processing step S3. In the folding processing step S2, a folded portion (66a) is formed by folding a tip end portion of a shield wire (66) to the outer sheath (68) side with respect to the coaxial cable (60) including a central conductor (62), an insulator (64) provided around the central conductor (62), the shield wire (66) provided around the insulator (64), and the outer sheath (68) provided around the shield wire (66). In the burying processing step S3, a buried member (74) having insulating property or semiconductivity is disposed in a gap (72) formed between the folded portion (66a) and the insulator (64).

### TECHNICAL FIELD

The present invention relates to a method for processing a coaxial cable for applying a voltage to a time-of-flight mass spectrometer.

### BACKGROUND ART

In a time-of-flight mass spectrometer (TOFMS), ions to be analyzed are ejected from an ion ejection unit, and the ions fly in a hollow flight tube and then are detected by a detector. As a result, the time-of-flight of the ions until reaching the detector is measured, and the mass of the ions is identified based on the time of flight (refer to, for example, Patent Document 1 below).

In such a time-of-flight mass spectrometer, a voltage is applied to a predetermined component via a coaxial cable. For example, a high voltage is applied to a reflectron, a flight tube, and the like as the components via a coaxial cable.

### PRIOR ART DOCUMENT

### Patent Documents

Patent Document 1: JP-A-2017-59385

### SUMMARY OF THE INVENTION

### Problems to be Solved by the Invention

Since the time-of-flight of the ions measured in the time-of-flight mass spectrometer is affected by the voltage applied to the above components, the stability of the voltage is important in maintaining the measurement accuracy. Therefore, as the coaxial cable used in the time-of-flight mass spectrometer, it is preferable to use a high voltage coaxial cable provided with a shield wire for noise countermeasures. This type of coaxial cable includes a central conductor, an insulator provided around the central conductor, a shield wire provided around the insulator, and an outer sheath provided around the shield wire.

When the high-voltage coaxial cable is electrically connected to the component, first, the shield wire is exposed by removing a tip end portion of the outer sheath. Then, the shield wire is peeled off from the insulator so as to secure a necessary creepage distance. The shield wire is peeled off from the tip end side by a length corresponding to the creepage distance and folded back to the outer sheath side. Then, by fixing the coaxial cable from the outside of the folded shield wire via a metal clamp, the shield wire can be connected to the ground (earth) via the clamp.

When the shield wire is folded back toward the outer sheath side as described above, a gap may be generated between the insulator and the shield wire at a folded portion of the shield wire. As a result of intensive studies, the inventors of the present application have found that when a voltage is applied to the coaxial cable in a state where a gap is generated between the folded portion of the shield wire and the insulator, the electric field is disturbed in the gap, and local electric field concentration occurs, thereby causing partial discharge. When a voltage is applied to a predetermined component via a coaxial cable having a gap between the folded portion of the shield wire and the insulator, the voltage may include noise due to occurrence of partial discharge. In this case, an adverse effect caused by noise may occur in a component to which a voltage is applied via the coaxial cable.

For example, for the components such as the reflectron and the flight tube, since the applied voltage affects the time-of-flight of the ions, when the voltage is applied to these components via a coaxial cable having a gap between the folded portion of the shield wire and the insulator, the measurement result may be adversely affected.

The present invention has been made in view of the above circumstances, and an object of the present invention is to provide a method for processing a coaxial cable, which can reduce occurrence of a partial discharge caused by a gap between a folded portion of a shield wire and an insulator in the coaxial cable.

### Means for Solving the Problems

An aspect of the present invention is a method for processing a coaxial cable for applying a voltage to a time-of-flight mass spectrometer, the method including a folding processing step and a burying processing step. In the folding processing step, a folded portion is formed by folding a tip end portion of a shield wire to the outer sheath side with respect to the coaxial cable including a central conductor, an insulator provided around the central conductor, the shield wire provided around the insulator, and the outer sheath provided around the shield wire. In the burying processing step, a buried member having insulating property or semiconductivity is disposed in a gap formed between the folded portion and the insulator.

### Effects of the Invention

According to the present invention, it is possible to reduce occurrence of a partial discharge caused by a gap between a folded portion of a shield wire and an insulator in the coaxial cable.

### BRIEF DESCRIPTION OF THE DRAWINGS

FIG. 1 is a schematic view illustrating an example of a configuration of a time-of-flight mass spectrometer according to the present embodiment.

FIG. 2 is a schematic section view illustrating an example of a coaxial cable according to the present embodiment.

FIG. 3 is a flowchart illustrating an example of a method for processing a coaxial cable according to the present embodiment.

FIG. 4 is a diagram for explaining the method for processing a coaxial cable according to the present embodiment.

FIG. 5 is a diagram for explaining the method for processing a coaxial cable according to the present embodiment.

FIG. 6 is a diagram for explaining the method for processing a coaxial cable according to the present embodiment.

FIG. 7 is a graph for explaining an effect of the burying processing step according to the present embodiment.

### MODE FOR CARRYING OUT THE INVENTION

### 1. Overall Configuration of Time-of-Flight Mass Spectrometer

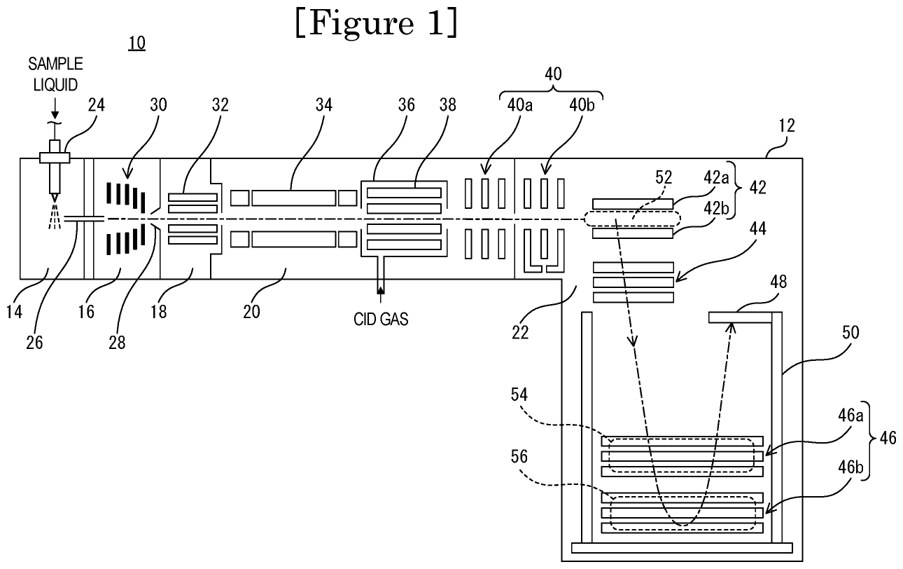

FIG. 1 is a schematic view illustrating an example of a configuration of a time-of-flight mass spectrometer (TOFMS) 10 according to the present embodiment. The time-of-flight mass spectrometer 10 includes a housing 12, and an ionization chamber 14, a first intermediate chamber 16, a second intermediate chamber 18, a third intermediate chamber 20, an analysis chamber 22, and the like are formed inside the housing 12. The inside of the ionization chamber 14 is substantially at atmospheric pressure. The first intermediate chamber 16, the second intermediate chamber 18, the third intermediate chamber 20, and the analysis chamber 22 are each brought into a vacuum state (negative pressure state) by driving of a vacuum pump (not shown). The ionization chamber 14, the first intermediate chamber 16, the second intermediate chamber 18, the third intermediate chamber 20, and the analysis chamber 22 communicate with each other, and are configured such that the degree of vacuum increases stepwise in this order.

The ionization chamber 14 is provided with a spray 24 made of, for example, an electro spray ionization (ESI) spray. A sample liquid containing each component in the sample supplied from the liquid chromatograph (not shown) is sprayed into the ionization chamber 14 by the spray 24 while being charged. As a result, ions derived from each component in the sample are generated. However, the ionization method used in the time-of-flight mass spectrometer 10 is not limited to ESI, and other ionization methods such as atmospheric pressure chemical ionization (APCI) and probe electro spray ionization (PESI) may be used.

The first intermediate chamber 16 communicates with the ionization chamber 14 via a heating capillary 26 including a small-diameter tube. The second intermediate chamber 18 communicates with the first intermediate chamber 16 via a skimmer 28 including a small hole. The first intermediate chamber 16 and the second intermediate chamber 18 are provided with ion guides 30 and 32 for sending ions to the subsequent stage while converging the ions, respectively.

The third intermediate chamber 20 is provided with, for example, a quadrupole mass filter 34, a collision cell 36, and the like. A collision induced dissociation (CID) gas such as argon or nitrogen is continuously or intermittently supplied into the collision cell 36. A multipole ion guide 38 is provided in the collision cell 36.

Ions flowing from the second intermediate chamber 18 into the third intermediate chamber 20 are separated according to the mass-to-charge ratio by the quadrupole mass filter 34, and only ions having a specific mass-to-charge ratio pass through the quadrupole mass filter 34. Ions having passed through the quadrupole mass filter 34 are introduced into the collision cell 36 as precursor ions, and come into contact with the CID gas to be cleaved, whereby product ions are generated. The generated product ions are temporarily held by the multipole ion guide 38 and released from the collision cell 36 at a predetermined timing.

In the third intermediate chamber 20 and the analysis chamber 22, a transfer electrode unit 40 is provided across these chambers. The transfer electrode unit 40 includes one or more first electrodes 40a provided in the third intermediate chamber 20 and one or more second electrodes 40b provided in the analysis chamber 22. The first electrode 40a and the second electrode 40b are formed in an annular shape, and are coaxially arranged side by side. Ions (product ions) emitted from the collision cell 36 are converged by passing through the inside of the first electrode 40a and the second electrode 40b in the transfer electrode unit 40.

In addition to the second electrode 40b, the analysis chamber 22 is provided with an orthogonal acceleration unit 42, an acceleration electrode unit 44, a reflectron 46, a detector 48, a flight tube 50, and the like. The flight tube 50 is, for example, a hollow member with both end portions opened, and the reflectron 46 is disposed inside the flight tube.

The ions emitted from the transfer electrode unit 40 are incident on the orthogonal acceleration unit 42. The orthogonal acceleration unit 42 includes a pair of electrodes 42a and 42b facing each other with a space therebetween. The pair of electrodes 42a and 42b extends in parallel to the incident direction of ions from the transfer electrode unit 40, and an orthogonal acceleration region 52 is formed between these electrodes.

One electrode 42b is constituted by a grid electrode having a plurality of openings. The ions incident on the orthogonal acceleration region 52 are accelerated in the direction orthogonal to the incident direction of the ions, pass through the opening of one electrode 42b, and are guided to the acceleration electrode unit 44. In the present embodiment, the orthogonal acceleration unit 42 constitutes an ion ejection unit that emits ions to be analyzed. The ions ejected from the orthogonal acceleration unit 42 are further accelerated by the acceleration electrode unit 44 and introduced into the flight tube 50.

The reflectron 46 provided in the flight tube 50 includes one or more first electrodes 46a and one or more second electrodes 46b. The first electrode 46a and the second electrode 46b each have a through hole through which ions pass, and are arranged coaxially along the axis of the flight tube 50. Different voltages are applied to the first electrode 46a and the second electrode 46b.

The ions introduced into the flight tube 50 are guided into a flight space formed in the flight tube 50, fly in the flight space, and then incident on the detector 48. Specifically, the ions introduced into the flight tube 50 are decelerated in a first region (first stage) 54 formed inside the first electrode 46a, and then are reflected by the second region (second stage) 56 formed inside the second electrode 46b, so that the ions are folded back in a U shape and incident on the detector 48.

The time-of-flight from when the ions are ejected from the orthogonal acceleration unit 42 to when the ions are incident on the detector 48 depends on the mass-to-charge ratio of the ions. Therefore, the mass-to-charge ratio of each ion can be calculated based on the time-of-flight of each ion ejected from the orthogonal acceleration unit 42, and a mass spectrum can be created.

### 2. Coaxial Cable

In the time-of-flight mass spectrometer 10, a voltage is applied to a predetermined component via a coaxial cable. For example, a voltage is applied via the coaxial cable to a component in which the applied voltage affects the time-of-flight of the ion, that is, the applied voltage affects the measurement result.

Examples of the component whose applied voltage affects the time-of-flight of ions include the reflectron 46 and the flight tube 50. Note that a power supply for applying a voltage to various components of the time-of-flight mass spectrometer 10 is not shown.

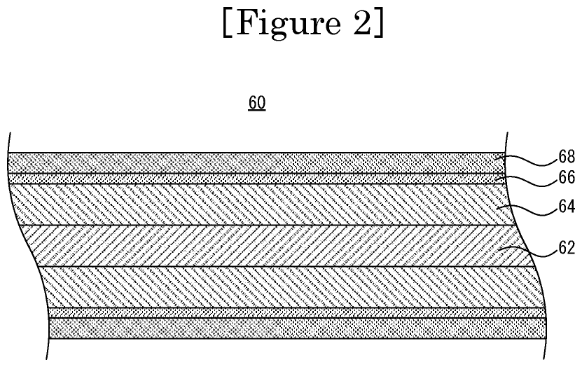

FIG. 2 is a schematic section view illustrating an example of the coaxial cable 60 according to the present embodiment. FIG. 2 illustrates a part of the coaxial cable 60. The coaxial cable 60 includes a central conductor 62, an insulator 64, a shield wire 66, and an outer sheath 68. The insulator 64 is provided around the central conductor 62. The shield wire 66 is provided around the insulator 64. The outer sheath 68 is provided around the shield wire 66.

The central conductor 62 is formed of one linearly extending metal wire. The insulator 64 is an insulating member such as polyethylene formed in a cylindrical shape, and the central conductor 62 penetrates the inside. The shield wire 66 includes a plurality of metal wires, and these metal wires are arranged to cover the insulator 64 in a mesh shape. The outer sheath 68 is an insulating member formed in a cylindrical shape, and has a function of covering and protecting the shield wire 66.

In the coaxial cable 60 illustrated in FIG. 2, the outer diameter of the outer sheath 68 is 3 to 7 mm, specifically, about 5 mm. The outer diameter of the central conductor 62 is 0.7 to 1.5 mm, specifically, about 1 mm. However, the central conductor 62 may include a plurality of metal wires. In addition, the shield wire 66 is not limited to the above configuration as long as noise can be suppressed from occurring in the voltage applied via the central conductor 62.

### 3. Process on Coaxial Cable

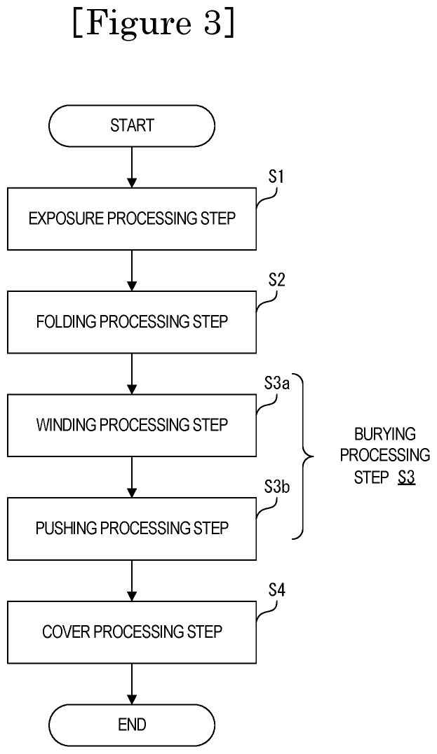

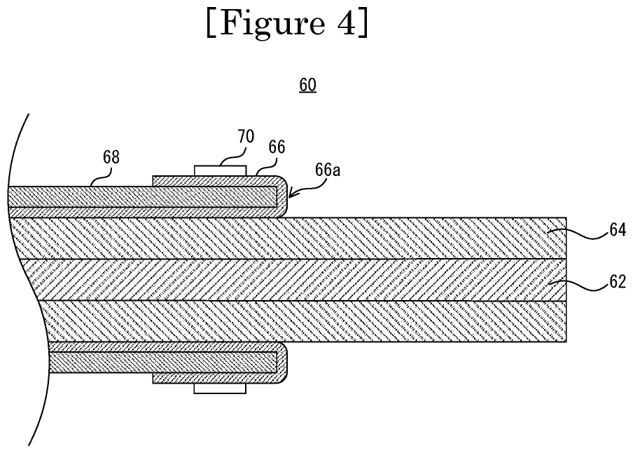

FIG. 3 is a flowchart illustrating an example of a method for processing the coaxial cable 60 according to the present embodiment. In the present embodiment, in the time-of-flight mass spectrometer 10, when the coaxial cable 60 is connected to a predetermined component, an exposure processing step (step S1), a folding processing step (step S2), a burying processing step (step S3), and a cover processing step (step S4) are performed in this order. Hereinafter, these steps will be described with reference to FIGS. 4, 5, and 6.

FIG. 4 is a diagram for explaining the method for processing the coaxial cable 60 according to the present embodiment. FIG. 4 is a schematic sectional view illustrating an end portion of the coaxial cable 60. Further, FIG. 4 illustrates the coaxial cable 60 after the exposure processing step and the folding processing step are performed.

The exposure processing step is a step of exposing the shield wire 66 of the coaxial cable 60 by removing a part (tip end portion) of the outer sheath 68. The folding processing step is a step of forming the folded portion 66a by folding back the tip end portion of the shield wire 66, specifically, the exposed portion of the shield wire 66 toward the outer sheath 68 side. Note that the folded portion 66a means a part where the shield wire 66 is folded, that is, a part of the folded shield wire 66 located closest to the tip end side of the coaxial cable 60.

In the example illustrated in FIG. 4, the shield wire 66 is connected to ground (earth) via a clamp 70 made of conductive metal. Specifically, the shield wire 66 is peeled off from the tip end side by a length corresponding to a necessary creepage distance, and is folded back along the surface of the outer sheath 68. Then, by fixing the coaxial cable 60 via the clamp 70 from the outside of the folded shield wire 66, the shield wire 66 can be connected to the ground via the clamp 70. When the shield wire 66 is connected to the ground via a terminal or the like, the folding processing step is not limited to the step of folding back the shield wire 66 by 180 degrees, and may be a step of folding back the shield wire at an angle of 90 degrees or more and less than 180 degrees.

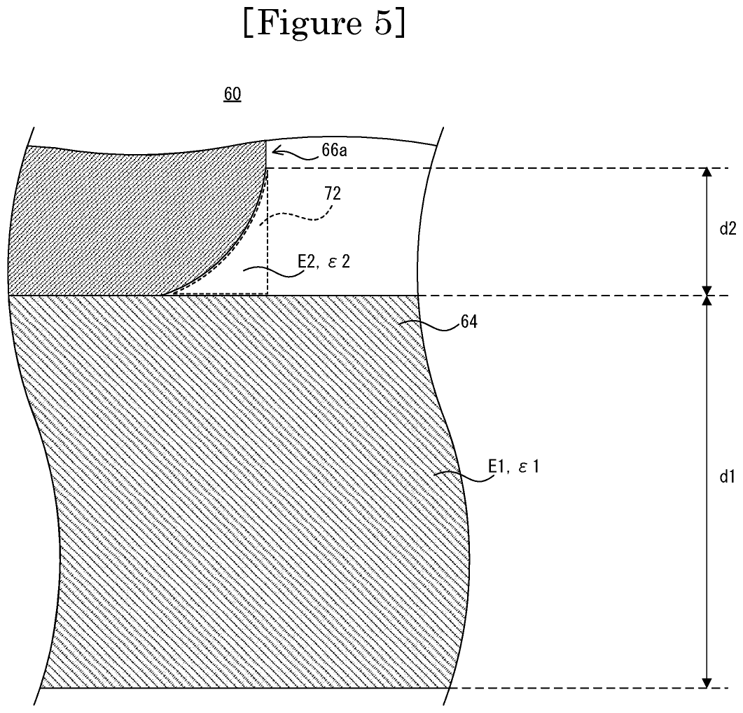

FIG. 5 is a diagram for explaining the method for processing the coaxial cable 60 according to the present embodiment. FIG. 5 is an enlarged schematic sectional view of the periphery of the folded portion 66a of the coaxial cable 60. When the folding processing step is performed on the coaxial cable 60, as illustrated in FIG. 5, a gap 72 is formed between the folded portion 66a and the insulator 64. A thickness d1 of the insulator is larger than a thickness d2 of the gap.

Since a dielectric constant ε1 of the insulator 64 is higher than a dielectric constant ε2 of air, an electric field E2 in the gap 72 is larger than an electric field E1 in the insulator 64. Therefore, in the time-of-flight mass spectrometer 10, when a voltage is applied to a predetermined component via the central conductor 62 of the coaxial cable 60, the electric field is disturbed in the gap 72, and local electric field concentration occurs, so that partial discharge may occur in the gap 72.

For example, for components such as the reflectron 46 and the flight tube 50, a high voltage of several kv to several tens of kv may be applied via the coaxial cable 60, and in such a case, a partial discharge of about several hundred m V may occur in the gap 72.

The voltage applied via the coaxial cable 60 having the gap 72 between the folded portion 66a of the shield wire 66 and the insulator 64 includes noise due to partial discharge caused by the gap 72. In particular, in the components such as the reflectron 46 and the flight tube 50, since the applied voltage affects the time-of-flight of the ions, if noise is included in the voltage, the measurement result is adversely affected.

In addition, in the time-of-flight mass spectrometer 10, the polarity of the voltage, that is, the positive and negative may be reversed in order to change the polarity of the ions to be measured, and even in such a case, a partial discharge may occur in the gap 72. If the partial discharge occurs in the gap 72 as the polarity of the voltage is reversed, the electric field in the gap 72 is stabilized, and it takes time for the partial discharge to settle. That is, when the polarity of the voltage is reversed in order to change the polarity of the ions to be measured, there is a possibility that the waiting time until the next mass spectrometry is performed becomes long.

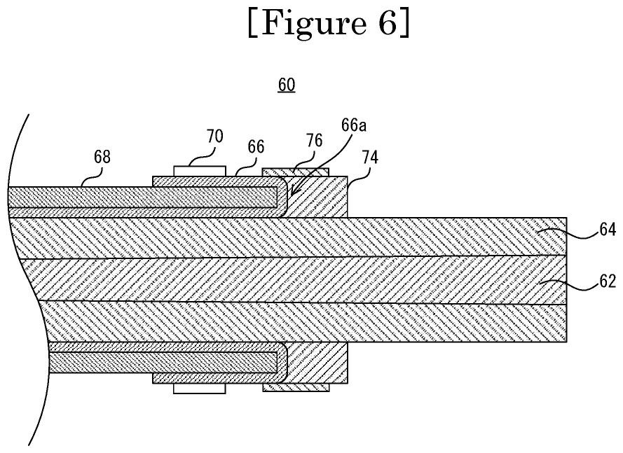

Therefore, in the present embodiment, the burying processing step is performed on the coaxial cable 60. FIG. 6 is a diagram for explaining the method for processing the coaxial cable 60 according to the present embodiment. FIG. 6 is a schematic sectional view illustrating an end portion of the coaxial cable 60. Further, FIG. 6 illustrates the coaxial cable 60 after the burying processing step and the cover processing step are performed.

The burying processing step is a step of disposing a buried member 74 having insulating property or semiconductivity is disposed in the gap 72 formed between the folded portion 66a and the insulator 64. The insulating property means having no conductivity at all, and the semiconductivity means having slightly more conductivity than the insulating property, for example, having a volume resistivity of about 10³ to 10¹² Ω·cm.

In the present embodiment, when a tape-shaped member is used as the buried member 74, the burying processing step includes a winding processing step (step S3a) and a pushing processing step (step S3b) as illustrated in FIG. 3, and is performed in this order.

The winding processing step is a step of winding the tape-shaped buried member 74 around an outer peripheral surface of the insulator 64 on the tip end side of the coaxial cable 60 with respect to the folded portion 66a. The pushing processing step is a step of pushing the tape-shaped buried member 74 wound around the outer peripheral surface of the insulator 64 toward the folded portion 66a side. The thickness of the tape-shaped buried member 74 is smaller than the thickness d2 (refer to FIG. 5) of the gap 72. In the winding processing step, the tape-shaped buried member 74 is preferably wound around the insulator 64 so as to enter the gap 72. However, after the tape-shaped buried member 74 is wound around the outside of the gap 72 (the tip end side of the coaxial cable 60), the buried member 74 may be pushed in in the pushing processing step, so that the buried member 74 enters the gap 72.

According to the winding processing step, the buried member 74 can be easily disposed in the gap 72, and according to the pushing processing step, the buried member 74 is pushed into the gap 72, so that the gap 72 can be filled as much as possible.

Note that the shape of the buried member 74 is not particularly limited as long as it has the insulating property or the semiconductivity and can be disposed in the gap 72. Therefore, as the buried member 74, for example, an adhesive material made of a resin or silicon can also be used.

Further, in the present embodiment, the buried member 74 may have a self-fusion property. When the tape-shaped buried member 74 having the self-fusion property is wound around the outer peripheral surface of the insulator 64, the stacked buried members 74 are fused to each other, so that the buried member 74 can be easily wound without using an adhesive material. In addition, when a member having a self-fusion property is used as the buried member 74, the gap 72 can be easily filled. Furthermore, according to the buried member 74 having the self-fusion property, the gap 72 can be filled without generating an air layer in the buried member 74.

For example, when an insulating tape having the self-fusion property is used as the buried member 74, the gap 72 can be filled as much as possible while the buried member 74 is easily disposed in the gap 72. Further, since the insulating tapes are fused to each other, the gap 72 can be filled without generating an air layer between the overlapping insulating tapes.

In the present embodiment, from the viewpoint of protecting the buried member 74, the cover processing step is performed after the burying processing step. However, as illustrated in FIG. 6, the cover processing step can be performed in a case where the shield wire 66 is folded back along the surface of the outer sheath 68.

The cover processing step is a step of disposing a cover member 76 around the buried member 74. As the cover member 76, a tubular or tape-shaped member can be used, and for example, a heat shrinkable tube is suitably used. According to the cover processing step, it is possible not only to protect the buried member 74 but also to prevent the buried member 74 from separating from the coaxial cable 60.

In addition, in a case where the cover member 76 is disposed around the buried member 74, it is possible to prevent the buried members 74 of the coaxial cables 60 from coming into contact with each other when the plurality of coaxial cables 60 are stored side by side before manufacturing the device or the like. For example, when a member having the self-fusion property is used as the buried member 74, it is possible to prevent the buried members 74 of the coaxial cables 60 from being fused to each other.

In the cover processing step, as illustrated in FIG. 6, the cover member 76 is preferably disposed such that a part of the cover member 76 is positioned around the folded portion 66a. If a part of the cover member 76 is positioned around the folded portion 66a, the buried member 74 can be prevented from moving along the length direction of the coaxial cable 60.

The cover member 76 is not particularly limited as long as it can be disposed around the buried member 74, but it is preferable to use a member having thermal shrinkage. When a member having thermal shrinkage is used as the cover member 76, the cover processing step includes a step of applying heat to the cover member 76 disposed around the buried member 74.

According to the cover member 76 having the thermal shrinkage, the cover member 76 is disposed in close contact with the periphery of the buried member 74. That is, according to the cover member 76 having the thermal shrinkage, the buried member 74 is firmly fixed to the coaxial cable 60, specifically, the insulator 64. From this, if a part of the cover member 76 is positioned around the folded portion 66a, the buried member 74 is firmly fixed to the folded portion 66a.

### 4. Measurement Results

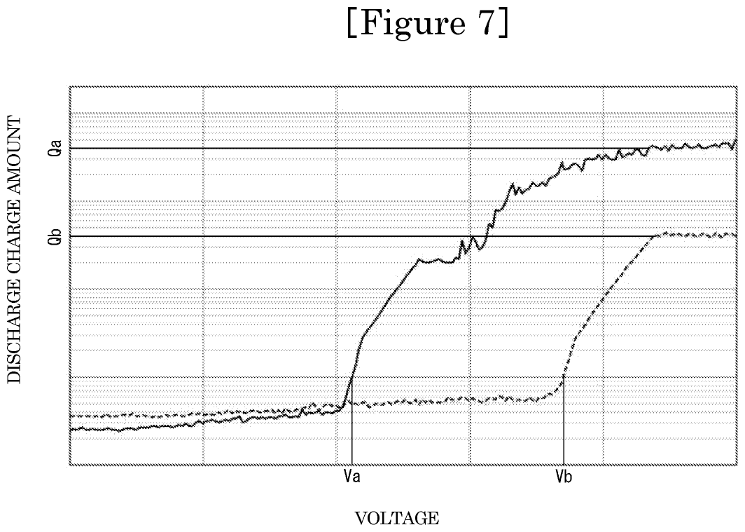

FIG. 7 is a graph for explaining an effect of the burying processing step according to the present embodiment. FIG. 7 is a graph showing a result of measuring discharge in the gap 72 using a partial discharge measuring device. FIG. 7 illustrates a discharge charge amount when a voltage is applied to the coaxial cable 60, where a horizontal axis represents the applied voltage and a vertical axis represents the discharge charge amount.

The larger the discharge charge amount, the larger the generation amount of the partial discharge caused by the gap 72. The voltage applied to the coaxial cable 60 may be a DC voltage or an AC voltage. Note that the AC voltage here includes a case where the voltage shows a rectangular wave by alternately switching the polarity of the voltage between positive and negative.

Specifically, a solid line indicates a discharge charge amount corresponding to the coaxial cable 60 on which the burying processing step has not been performed, and a broken line indicates a discharge charge amount corresponding to the coaxial cable 60 on which the burying processing step has been performed. The value of a voltage Vb in FIG. 7 is larger than the value of a voltage Va, and the value of a discharge charge amount Qa is larger than the value of a discharge charge amount Qb.

In the coaxial cable 60 in which the burying processing step is not performed, when the voltage Va is applied, the discharge charge amount rapidly increases, that is, partial discharge occurs in the gap 72. In addition, when a voltage higher than the voltage Va is applied to the coaxial cable 60, the discharge charge amount increases to Qa accordingly.

On the other hand, when the voltage Va is applied to the coaxial cable 60 subjected to the burying processing step, the discharge charge amount is stable, that is, no partial discharge occurs in the gap 72. In addition, when the voltage Vb is applied to the coaxial cable 60 on which the burying processing step has been performed, the discharge charge amount rapidly increases, but the discharge charge amount increases only up to Qb.

That is, according to the burying processing step, the occurrence of partial discharge in the gap 72 is reduced. In addition, even if a partial discharge occurs in the gap 72, the discharge charge amount is small, and thus the content of noise in the applied voltage is reduced. For example, if a voltage is applied to the components such as the reflectron 46 and the flight tube 50 via the coaxial cable 60 subjected to the burying processing step, adverse effects associated with the occurrence of the partial discharge in the measurement result are reduced.

In addition, if the occurrence of the partial discharge in the gap 72 is reduced by the burying processing step, it is possible to prevent the standby time until the partial discharge is settled from becoming long when the polarity of the voltage is reversed in order to change the polarity of the ions to be measured in the time-of-flight mass spectrometer 10.

Although not illustrated in FIG. 3, in the present embodiment, in addition to the exposure processing step, the folding processing step, and the like, a step necessary for connecting the coaxial cable 60 to a predetermined component, for example, a step of exposing the central conductor 62, and the like are also performed. In addition, the specific configuration, method, and the like described in the present embodiment are merely examples, and can be appropriately changed according to an actual product. Furthermore, in each step of the flow diagram illustrated in the present embodiment, the order of processing can be appropriately changed as long as the same result is obtained.

### 5. Aspects

It is understood by those skilled in the art that exemplary embodiments described above are specific examples of the following aspects.

(Aspect 1) According to an aspect, there is provide a method for processing a coaxial cable for applying a voltage to a time-of-flight mass spectrometer, the method may include
a folding processing step of forming a folded portion by folding a tip end portion of a shield wire to an outer sheath side with respect to the coaxial cable including a central conductor, an insulator provided around the central conductor, the shield wire provided around the insulator, and the outer sheath provided around the shield wire; and
a burying processing step of disposing a buried member having insulating property or semiconductivity in a gap formed between the folded portion and the insulator.

According to the method for processing a coaxial cable according to Aspect 1, wherein since the buried member having the insulating property or the semiconductivity is disposed in the gap between the folded portion of the shield wire and the insulator in the coaxial cable, it is possible to reduce the occurrence of partial discharge caused by the gap. If the occurrence of the partial discharge in the coaxial cable is reduced, it is possible to reduce an adverse effect generated in the measurement result in the time-of-flight mass spectrometer. In addition, if the occurrence of the partial discharge in the coaxial cable is reduced, it is possible to prevent the standby time until the partial discharge is settled from becoming long when the polarity of the voltage is reversed in order to change the polarity of the ions to be measured in the time-of-flight mass spectrometer.

(Aspect 2) The method for processing a coaxial cable according to Aspect 1, wherein
the burying processing step may include a step of winding the tape-shaped buried member around an outer peripheral surface of the insulator on a tip end side of the coaxial cable with respect to the folded portion.

According to the method for processing a coaxial cable according to Aspect 2, wherein the buried member can be easily disposed in the gap between the folded portion of the shield wire and the insulator.

(Aspect 3) The method for processing a coaxial cable according to Aspect 2, wherein
the burying processing step may include a step of pushing the tape-shaped buried member wound around the outer peripheral surface of the insulator toward the folded portion side.

According to the method for processing a coaxial cable according to Aspect 3, wherein since the buried member is pushed into the gap between the folded portion of the shield wire and the insulator, the gap can be filled as much as possible. Therefore, it is possible to further reduce the occurrence of a partial discharge caused by the gap between the folded portion of the shield wire and the insulator in the coaxial cable.

(Aspect 4) The method for processing a coaxial cable according to Aspect 2, wherein
the buried member may have a self-fusion property.

According to the method for processing a coaxial cable according to Aspect 4, wherein the gap between the folded portion of the shield wire and the insulator can be easily filled, and the gap can be filled without generating an air layer in the buried member. Therefore, it is possible to further reduce the occurrence of a partial discharge caused by the gap between the folded portion of the shield wire and the insulator in the coaxial cable.

(Aspect 5) The method for processing a coaxial cable according to Aspect 1
may further include a cover processing step of disposing a cover member around the buried member.

According to the method for processing a coaxial cable according to Aspect 5, wherein it is possible to prevent the buried member from separating from the coaxial cable while protecting the buried member. According to such a processing method, it is possible to prevent the buried members from coming into contact with each other in the coaxial cables.

(Aspect 6) The method for processing a coaxial cable according to Aspect 5, wherein
in the cover processing step, the cover member may be disposed such that a part of the cover member is positioned around the folded portion.

According to the method for processing a coaxial cable according to Aspect 6, wherein it is possible to prevent the buried member from moving along the length direction of the coaxial cable.

(Aspect 7) The method for processing a coaxial cable according to Aspect 5, wherein
the cover member may have thermal shrinkage, and
the cover processing step may include a step of applying heat to the cover member disposed around the buried member.

According to the method for processing a coaxial cable according to Aspect 7, wherein the cover member in close contact with the periphery of the buried member can be disposed. Therefore, the buried member can be firmly fixed to the coaxial cable.

### DESCRIPTION OF REFERENCE SIGNS

10 time-of-flight mass spectrometer
60 coaxial cable
62 central conductor
64 insulator
66 shield wire
66a folded portion
68 outer sheath
72 gap
74 buried member
76 cover member
S2 folding processing step
S3 burying processing step
S4 cover processing step

1. A method for processing a coaxial cable for applying a voltage to a time-of-flight mass spectrometer, the method comprising:
a folding processing step of forming a folded portion by folding a tip end portion of a shield wire to an outer sheath side with respect to the coaxial cable including a central conductor, an insulator provided around the central conductor, the shield wire provided around the insulator, and the outer sheath provided around the shield wire; and
a burying processing step of disposing a buried member having insulating property or semiconductivity in a gap formed between the folded portion and the insulator.

2. The method for processing a coaxial cable according to claim 1, wherein the burying processing step includes a step of winding the tape-shaped buried member around an outer peripheral surface of the insulator on a tip end side of the coaxial cable with respect to the folded portion.

3. The method for processing a coaxial cable according to claim 2, wherein the burying processing step includes a step of pushing the tape-shaped buried member wound around the outer peripheral surface of the insulator toward the folded portion side.

4. The method for processing a coaxial cable according to claim 2, wherein the buried member has a self-fusion property.

5. The method for processing a coaxial cable according to claim 1, further comprising: a cover processing step of disposing a cover member around the buried member.

6. The method for processing a coaxial cable according to claim 5, wherein in the cover processing step, the cover member is disposed such that a part of the cover member is positioned around the folded portion.

7. The method for processing a coaxial cable according to claim 5, wherein
the cover member has thermal shrinkage, and
the cover processing step includes a step of applying heat to the cover member disposed around the buried member.
